(19) United States
(12) Patent Application Publication
(10) Pub. No.: US 2004/0220816 A1
(43) Pub. Date: Nov. 4, 2004

(54) Business method for facilitating payment to developer or builder of referral fee for future real estate listing

(75) Inventor: Edward Jonathan Brush, Columbia, MD (US)

Correspondence Address: GRAY CARY WARE & FREIDENRICH LLP, 153 TOWNSEND, SUITE 800, SAN FRANCISCO, CA, 94107, US

(73) Assignee: HOUSING OPPORTUNITY CORPORATION

(21) Appl. No.: 10/426,812

(22) Filed: May 1, 2003

(51) Int. Cl. G06F 17/60

(52) U.S. Cl. 705/1

(57) ABSTRACT

A developer or builder offers a prospective purchaser a financial incentive in exchange for agreeing to a future listing to sell the home through a real estate agent or broker with whom the developer or builder has a relationship. Upon making the agreement, the developer or builder provides the agreed upon discount and provides the referral to the real estate agent or broker that has been chosen by the prospective purchaser. The real estate agent or broker has agreed to pay a referral fee when the future listing results in sale of the home. When the purchaser decides to sell the home, the home is listed with the real estate agent or broker. When the sale of the home is completed, an agreed-upon referral fee is paid to a middleman who takes a commission and gives the rest to the developer or builder. The middleman has created a list of real estate agents or brokers from whom the prospective purchaser can choose a desired agent or broker. The middleman creates a data base that permits monitoring of any and all transactions that might occur vis.a.vis homes that are subject to the future referral agreements.

### BACKGROUND OF THE INVENTION

In the real world of real estate development, it is often the case that the developer or builder is not enamored of the real estate agent who brings him or her a buyer for the home he has constructed. The developer or builder has to acquire the land and deal with all of the regulatory issues that are conditions precedent to the right to build on the land. These issues may include zoning, permission to fill and grade, compliance with architectural covenants, dealing with neighborhood associations, and compliance with a myriad of regulations such as those that exist when one wishes to develop near a body of water. After successfully crossing all of these hurdles, at considerable time and expense, often the difference between cost and profit is quite slim. Thus, when the developer or builder has to pay a commission of up to 5% to 7% of the asking price for the home he or she has built, and, in anticipation of that fact, has built-in this anticipated expense, the profit margin remains tight indeed.

There are approximately 1,000,000.00 new homes sold every year. The top 20 developers or builders produce about 25% of those homes or in the neighborhood of 250,000.00 homes each year. Developers or builders pay over 3 billion dollars in real estate fees and commissions per year and gain no perceptible value for those payments. This makes it likely that developers or builders will participate in the business method in accordance with the teachings of the present invention to facilitate recovery of some significant percentage of these outlays.

Most developers or builders, given their druthers, would much prefer to sell homes they develop or build to the purchasers directly. More often than not, the reality is that it is not possible to adequately market new homes without the assistance of a real estate broker or agent. This is particularly true in the upper brackets where prospective purchasers rarely look for a home to purchase without the assistance of a real estate agent or broker.

Under these circumstances, if a developer or builder could operate under a system in which he or she is able to recoup some of the losses incurred through payment of real estate commissions, the developer or builder would be delighted to participate in such a program. It is with this desire in mind that the present invention was developed.

### SUMMARY OF THE INVENTION

The present invention relates to a business method for facilitating payment to a developer or builder of a referral fee for a future real estate listing. The present invention includes the following interrelated objects, aspects and features:

(1) In accordance with the teachings of the present invention, the developer or builder offers the prospective purchaser a financial incentive in exchange for agreeing in writing to a future listing to sell the home when the buyer is ready to sell, through a real estate agent or broker with whom the developer or builder has a relationship.

(2) In order to facilitate the transaction, the developer or builder either obtains a broker's license or enters into a legal relationship with a real estate broker so that referral fees can legally and ethically be paid to the developer or builder. As another alternative, a limited liability corporation (LLC) is created and the developer or builder is given a percentage ownership in the LLC based upon the amounts reduced or rebated to the prospective purchaser as an incentive for signing the listing. When the prospective purchaser is negotiating a purchase price with the developer or builder, one of the items that is negotiated is the closing costs for the transaction. These closing costs include title insurance fees, settlement agent charges, as well as numerous different kinds of taxes and fees. Some of these charges can be discounted and others, for example, taxes, cannot. Concerning those charges that can be discounted, during the course of negotiations to purchase the home, the developer or builder offers the prospective purchaser a financial incentive in the form of, for example, either a discount on some of the closing costs or a discount on the purchase price for the home. The condition precedent to the developer or builder agreeing to discount those fees or prices is the written agreement by the prospective purchaser that should the prospective purchaser purchase the home, he or she will agree, when the time comes to sell the home, sometime in the future, they will list the home with a real estate agent designated by the prospective purchaser or middleman and with whom the prospective purchaser or middleman has a written relationship. Upon making the agreement, the developer or builder provides the agreed upon discount and when the purchase of the home is completed, provides the referral to the real estate agent that has been chosen by the prospective purchaser, or the middleman if no choice is made.

(3) From the perspective of the purchaser, when the purchaser agrees to buy the home from the developer or builder, the purchaser accepts the financial incentive that has been offered by the developer or builder and agrees to refer the future sale of the home to a real estate agent to be designated by the prospective purchaser or middleman. The transaction is settled and the purchaser moves into the home, occupies it or, in the case of an investment property, rents it out. Shortly, the purchaser is contacted by the real estate agent that has been chosen by the developer or builder and a relationship is developed between the real estate agent and the purchaser. When, eventually, the purchaser decides to sell the home, the same real estate agent or their firm, as the case may be, is retained to sell the home.

(4) The real estate agent or broker has entered into an agreement with the developer or builder whereby the real estate agent or broker has agreed to receive future real estate listings in exchange for payment of a referral fee when the future listing results in sale of the home. The real estate agent or broker receives word from the developer or builder when the home is purchased by the purchaser and contacts the purchaser to establish a relationship with the purchaser. That relationship is maintained over the years during the ownership of the home by the purchaser. When the purchaser decides to sell the home, as per the agreement between the purchaser and the real estate agent or broker, the home is listed with the real estate agent. When the sale of the home is completed, an agreed-upon referral fee is paid to a middleman who takes a commission and pays the rest to the developer or builder.

(5) The middleman has entered into an agreement with the developer or builder to facilitate the intended transaction. In that agreement, the developer or builder has been provided a pre-printed agreement that can be signed by the prospective purchaser so that the agreement regarding future real estate listing can be entered into. The middleman has created a list of real estate agents and brokers from whom the prospective purchaser can choose a desired agent or broker and has ensured that all of the real estate agents and brokers that have entered into the agreement have agreed to pay the referral fee required under the system. The middleman creates a data base using a computer program that permits monitoring of any and all transactions that might occur vis.a.vis homes that are subject to the future referral agreements. When such a home enters the Multiple Listing Service or some other marker indicates to the middleman that the home is up for sale, the middleman checks on the situation to ensure that the approved real estate agent or broker has been hired to conduct the transaction. Presuming this has occurred, the middleman coordinates with the real estate agent or broker to ensure that the agreed-upon referral fee is paid to the middleman. When this occurs, the middleman forwards the referral fee to the developer or builder or the broker on behalf of the developer or the LLC after subtracting the commission that has been previously agreed upon between the middleman and the developer or builder.

(6) One attractive feature for the developer or builder is that, customarily, home prices continually increase over time. Thus, in the future, when the home is re-sold and the referral fee is to be paid, since the referral fee is preferably calculated as a percentage of the real estate commission to be earned, that referral fee appreciates over time proportionally to the degree of appreciation of the home that is the subject of the agreement. In this way, in some fashion, the referral fee paid to the developer or builder is in the nature of an investment that pays an enhanced return based upon appreciation of the home.

Accordingly, it is a first object of the present invention to provide a business method for facilitating payment to a developer or builder of a referral fee for future real estate listing.

It is a further object of the present invention to provide such a business method in which a middleman is interposed between a developer or builder, real estate agent and prospective purchaser to facilitate payment of referral fees for future listings.

It is a still further object of the present invention to provide such a business method in which a prospective home purchaser receives a financial incentive in the form of reduction of closing costs or home purchase costs in exchange for granting of a future listing for which a referral fee will be paid to a developer or builder via a middleman.

It is a still further object of the present invention to provide such a business method in which real estate agents and brokers agree to pay referral fees for future listings.

It is a still further object of the present invention to provide such a business method in which a middleman monitors home sales to determine whether referral fees are to be paid, collects those fees, retains a commission, and pays the rest to developers or builders, directly, via a broker or via an LLC.

These and other objects, aspects and features of the present invention will be better understood from the following detailed description of the preferred embodiment when read in conjunction with the appended drawing figures.

### BRIEF DESCRIPTION OF THE DRAWINGS

FIG. 1 shows a schematic representation of the inventive business method from the perspective of the middleman.

FIG. 2 shows a schematic representation of the inventive business method from the perspective of the developer or builder.

FIG. 3 shows a schematic representation of the inventive business method from the perspective of the buyer or purchaser.

FIG. 4 shows a schematic representation of the inventive business method from the perspective of the real estate agent.

### SPECIFIC DESCRIPTION OF THE PREFERRED EMBODIMENT

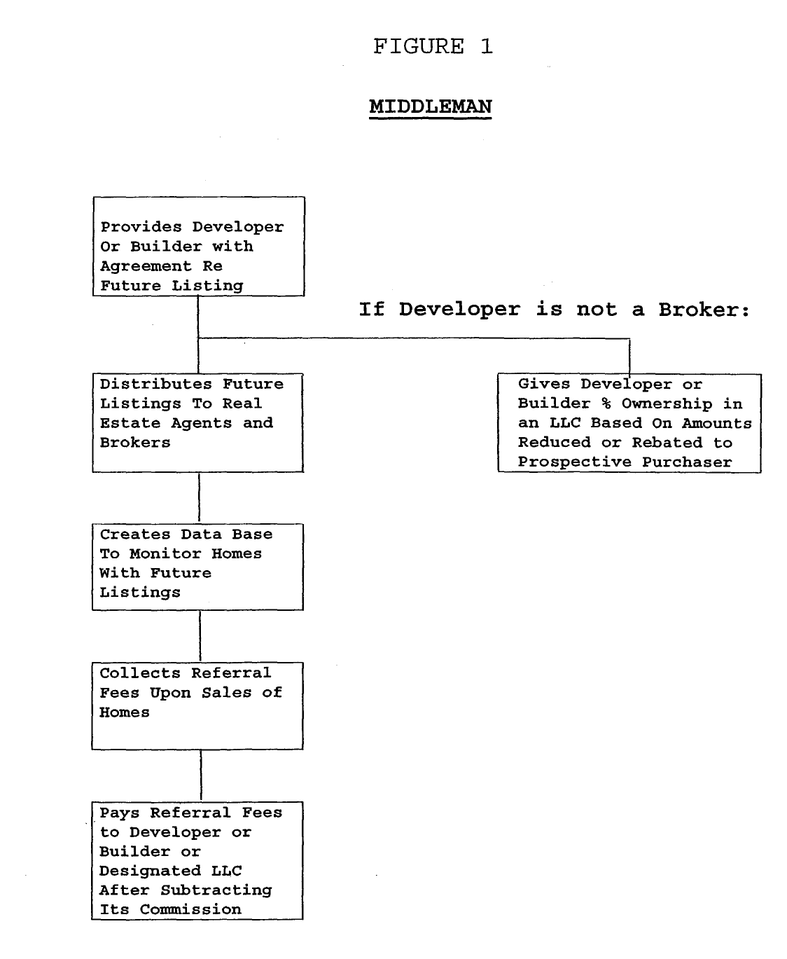

With reference to FIG. 1, the middleman can be important to the entirety of the business method for a number of reasons. First, the middleman creates the agreement forms that are signed between the middleman and a real estate agent, broker or firm, between the middleman and the developer or builder, and between the developer or builder and the prospective purchaser.

Second, the middleman creates a computer system that is used to monitor real estate transactions involving homes subject to an agreement for a future real estate listing. When such an agreement is entered into between a developer or builder and a prospective and soon-to-be purchaser, a copy of the agreement is forwarded to the middleman who enters the home address, tax map information, and purchaser name into the middleman's computer system so that the status of the home in question can be closely monitored.

One way of monitoring the home is to ensure that whenever the home, by an identifier such as the owner's name, the street address, the tax map number, the subdivision identifier, etc., comes up for sale, the middleman will become apprised of this fact to ensure that the sale of the residence, sometime in the future, occurs in accordance with the agreements that have been reached as detailed herein.

In operating the inventive business method, the middleman must create a network of real estate agents or brokers that are agreeable to paying a referral fee in exchange for a future listing of a home to be sold at some indeterminate time in the future. Given the advertising costs of a real estate firm, it is not difficult to imagine successful real estate firms entering into such an agreement because, without advertising costs, the inventive business method provides a steady stream of listings to the firm. The commissions required to be paid in exchange for the future listings do not have to be paid until the future listing results in a future sale. The commission charged by the middleman for entering into the agreement is typically in the range of 20 to 25% and is far less than the costs that would be incurred by the firm in obtaining such a listing. This makes the business method attractive to the real estate firm.

When a home that is subject to agreements in accordance with the business method is sold, at settlement, the referral fee is paid to the middleman. The middleman deposits the funds, subtracts an agreed-upon commission, and forwards the rest of the funds to the developer or builder. The developer or builder, in order to legally receive the funds, must also have a broker's license. Alternatively, the developer or builder can enter into a relationship with a broker for the purpose of receiving the fees. As a further alternative, an LLC is created and the developer or builder is given a percentage of ownership in the LLC based upon the amounts reduced or rebated to the prospective purchaser as an incentive for signing the listing. When the net referral fee (the referral fee less middleman commission) is paid to the LLC, the LLC pays the developer or builder a distribution based upon the value of the developer's or builder's ownership share.

The middleman can provide numerous services including the following:

(1) Providing training to real estate agents and brokers to effectuate the inventive system;

(2) Development of a sophisticated computer program to store data for the various properties covered by agreements in accordance with the teachings of the present invention so that monitoring can be conducted, particularly of the Multiple Listing Service, in order to track, collect and distribute referral fees back to the developer or builder while collecting middleman commissions;

(3) The middleman can create a method of ensuring the future home seller's willingness to participate in the system in accordance with the teachings of the present invention including providing a program consisting of a package of incentives that are currently offered by developers or builders when securing mortgage and title work from the prospective purchaser;

(4) The middleman provides a schedule and other information that helps the real estate agent or broker to maintain regular contact with the prospective purchaser and future owner during the term of ownership of the home in question;

(5) Through a list of real estate agents and brokers, the prospective purchaser is able to choose one of a number of agents or brokers that the prospective purchaser prefers presuming those agents and brokers are listed on the list of approved entities that have pre-existing agreements with the middleman;

(6) If desired or appropriate, the middleman can develop a nationwide sales force to contact developers or builders and obtain their agreements to enter into the program and will develop a list of agents and brokers who are willing to cooperate in the system;

(7) Additionally, the middleman can develop a process for delivering the required contracts and any necessary marketing materials to participating developers or builders while developing a tracking system to ensure that all executed contracts are received and processed by the middleman;

(8) With the help of outside counsel, the middleman creates agreements that are necessary for all participating parties to the transaction including prospective purchasers and homeowners, developers or builders, real estate agents and brokers, and the middleman;

(9) As explained above, a list of participating real estate agents and brokers is created and continually updated when agents are added and subtracted. If an agent is subtracted, any listings promised to that agent are rescinded and given to another agent in their place;

(10) A method may also be devised, as desired, to assist the middleman in assigning future listings to the various real estate agents and brokers for whom agreements have been reached. If the prospective purchaser has a preference of agent or broker, and that preference is on the approved list, that agent or broker will be chosen. Otherwise, a random selection system can be devised and implemented.

(11) The middleman can create the LLC for receipt of net referral fees.

The state-of-the-art computer system that is implemented by the middleman is required to be able to accomplish the following:

(1) Create a record for each prospective purchaser that signs up for the inventive system. This information should consist of property address, real estate agent or broker assigned to, developer or builder, date entered, and related data. This data base must be robust and provide the necessary redundancy, reliability and performance to provide high-speed relational access to any single record or group of records;

(2) Collect up-to-date real estate listing information from every necessary Multiple Listing Service on a regular basis;

(3) Each of these systems may consist of different platforms and applications for which a customized interface must be developed, tested and launched;

(4) The collected data must be sorted by region and compared against the master data base of participants in the inventive program to ensure any listing that is a listing of a property for which an agreement has been entered is tracked to the conclusion of a transaction;

(5) If a listing is discovered that has not been entered for a property by the real estate agent or broker to whom it was assigned, an exception report must be generated and customer service must follow-up with the assigned real estate agent or broker immediately to see what has happened;

(6) Once the transaction is recorded as a completed sale, accounting must be notified and a receivable recorded for that particular real estate agent or broker;

(7) If the listing is pulled without a sale, a report must be generated and a communication sent to the participating real estate agent or broker;

(8) Once a listing has generated revenue, it needs to be pulled from the system to ensure continued performance without old data causing degradation of system performance;

(9) Information on the sale should be entered into a separate data base so future product offerings from the inventive system can be sent to the new homeowner.

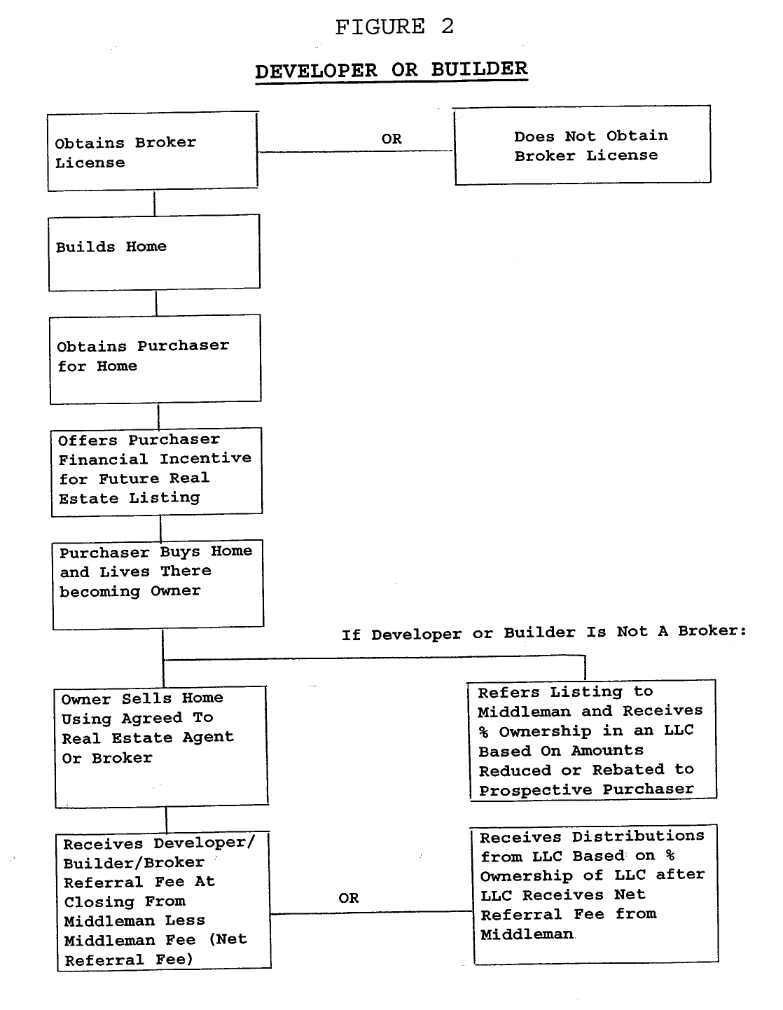

With reference to FIG. 2, an explanation will now be given of the business method from the perspective of the developer or builder. In order to facilitate collection of the referral fees, the developer or builder obtains a broker's license or enters into a relationship with a broker permitting the developer or builder to receive the referral fees via the broker or obtains a percentage of ownership in an LLC based upon the amounts reduced or rebated to the prospective purchaser as an incentive for signing the listing. The developer or builder builds a home and obtains a prospective buyer or purchaser for the home by any known method such as advertising in newspapers, journals and magazines, hiring a real estate agent to find buyers, or any other desired method. When the developer or builder is deciding upon the price for the home, the developer or builder builds into the pricing anticipated closing costs.

During the course of negotiations with the prospective purchaser concerning the home price and the closing costs, the developer or builder offers the prospective purchaser a financial incentive in exchange for the prospective purchaser agreeing that when, eventually, the prospective purchaser who has become the owner decides to sell the home, they will list the home for sale with a real estate agent of the prospective purchaser's choosing or a real estate agent known to the prospective purchaser provided that real estate agent has entered into an agreement with the middleman concerning the inventive business method. The agreement between the developer or builder and prospective purchaser is reduced to an agreed-upon writing and thereafter the prospective purchaser actually purchases the home and either lives there or keeps it for investment, renting it out or doing whatever he or she chooses with it.

Eventually, and on average, this occurs every six (6) years or so, the owner (previously known as the prospective purchaser) decides to sell the home. In accordance with the agreement made with the developer or builder in exchange for the financial incentive that was given when the home was originally purchased, the owner engages the services of the pre-chosen real estate agent or broker to list and sell the home. The home is sold using that agreed-upon real estate agent or broker. When the home is finally sold, the developer or builder receives the referral fee from the middleman in one of three ways after the middleman has subtracted their commission. The three ways are (1) directly, (2) via a broker, or (3) as a distribution from the LLC. From the perspective of the developer or builder, the fee collected is enhanced through appreciation of the home over time. For example, assuming that the home sold for $200,000.00, the real estate commission is 6%, the referral fee is 30% of the real estate commission, and the middleman's commission is 10%, the following numbers are illustrative. The developer or builder has given the prospective purchaser a financial incentive in the form of a $1,000.00 reduction in the closing costs, or purchase price.

At the sale price of $200,000.00, the total real estate commission is 6% but the commission earned by the listing agent is 3% or $6,000.00. At that level, the referral fee of 30%, the commission is $1,800.00, and of that amount, $600.00 is retained by the middleman and $1,200.00 goes to the developer or builder.

It is important to note that when the home sells, it will not sell for $200,000.00 because it has appreciated. In the current housing market, for example, in the Baltimore-Washington, D.C. area, if the home has been held for three or four years, it is likely that the sale price will be $300,000.00. If that is the sale price, the real estate commission is $18,000.00, and the listing agent's take is $9,000.00. The referral fee from that is 30% or $2,700.00, and the middleman takes $900.00 as the commission, leaving $1,800.00 paid to the developer or builder. Thus, the developer or builder receives a referral fee of $1,800.00, 80% more than the financial incentive he or she gave to the prospective purchaser before the deal was closed. It is difficult to find an investment that gives such a strong return over an average of 6 years.

It is easy for the developer or builder to incorporate the present invention into their current method of operating their business. The appropriate clauses that effectuate the present invention are integrated into the contracts the developer or builder currently uses as additional clauses including representation of relationships with title insurance agencies, closing agents and attorneys, and real estate agents so that any potential conflict issues can be considered and waived by the prospective purchaser in connection with receipt of the financial incentive. Upon completion of contracts including the appropriate clauses, the developer or builder sends copies of the completed contracts to the middleman for entry into the middleman's computer.

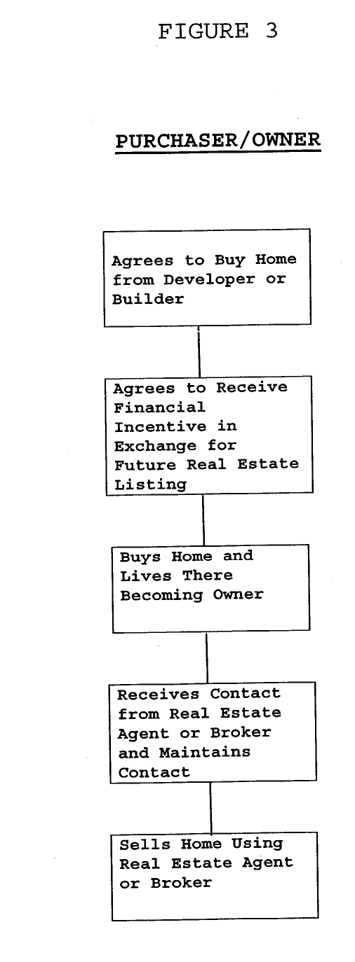

With reference now to FIG. 3, the inventive business method will be explained from the perspective of the prospective purchaser and actual eventual owner. With reference to FIG. 3, the prospective and eventual purchaser agrees to buy a home from the developer or builder. During the course of the negotiations between the prospective purchaser and the developer or builder, the prospective purchaser agrees to receive a financial incentive in terms of a reduction in purchase price or closing costs in exchange for agreeing that when the prospective purchaser has purchased the home and decides at some indeterminate time in the future to sell the home, the prospective purchaser, then the owner, will list the home for sale with a real estate agent chosen by the prospective purchaser. With this agreement in place, the prospective purchaser purchases the home by entering into a closing and either lives there or keeps the home for an investment of any kind including, as a rental property, etc. During the course of ownership, the now owner is contacted by the real estate agent chosen by the prospective purchaser and a relationship is maintained throughout the term of the owner's ownership of the home. When the time comes that the owner decides to sell the home, in accordance with the agreement made prior to closing the purchase, the owner contacts the real estate agent and engages their services to sell the home. The home is sold and the real estate agent pays the referral fee required in accordance with its contract with the middleman.

One aspect that ensures that a prospective purchaser will be willing to enter into an agreement involving the business method disclosed herein is the fact that when a prospective purchaser is thinking about purchasing the home, that prospective purchaser is not thinking about selling that home in the future. That prospective purchaser is only thinking about the financial incentive he or she will receive in accordance with the teachings of the present invention and is more likely than not to agree to it. On average, a home is sold every 6 years or so. Prospective purchasers are typically not looking that far into the future.

If at the time the prospective purchaser, now the owner, decides to sell the home, the owner attempts to sell the home without complying with the agreement they originally made with the developer or builder, such an action would breach a legally binding contract for which valid consideration has been given, namely, the financial incentive at closing. Additionally, the owner would be breaking the relationship that the real estate agent or broker has developed over his or her years of ownership of the home.

An effective way to incorporate the present invention into the transaction from the perspective of the prospective purchaser and eventual owner is for the developer or builder to approach the prospective purchaser about receiving a financial incentive in exchange for entering into an agreement pursuant to the present invention at the time mortgage and title work is commenced. By bundling this new benefit into this part of the transaction, the developer or builder can leverage their incentive beyond the normal inducement given for mortgage and title work by adding an additional benefit.

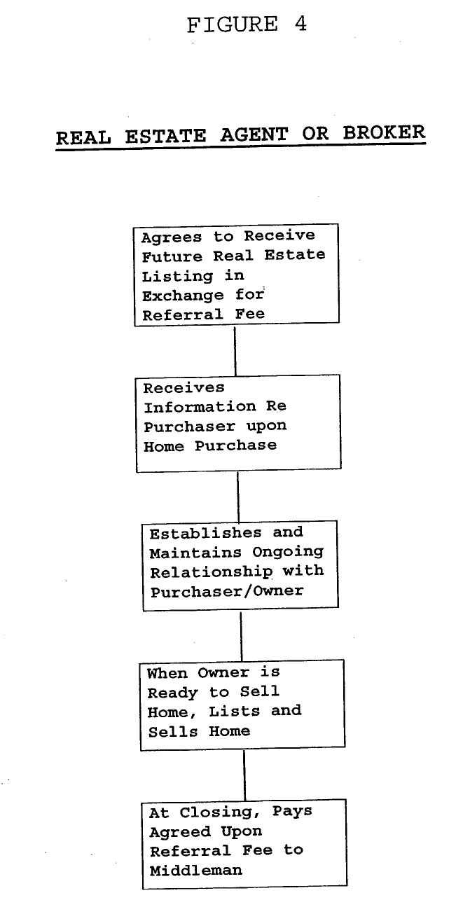

For the perspective of the real estate agent or broker, reference is now made to FIG. 4. The real estate agent or broker enters into an agreement with the developer or builder in which the agent or broker agrees to receive future real estate listings in exchange for payment of a referral fee upon sale of the underlying home. When the underlying home is purchased from the developer or builder, the middleman contacts the real estate agent or broker to provide information concerning the purchaser, now owner, so that the real estate agent or broker can contact the owner and establish an amicable relationship with them. The real estate agent or broker, in accordance with its agreement with the middleman, maintains that relationship by periodically contacting the owner in a non-intrusive way to maintain the relationship. When the owner is ready to sell the home, in accordance with the owner's agreement with the developer or builder, the owner contacts the real estate agent or broker and enters into a listing agreement with the real estate agent or broker so that the real estate agent or broker can sell the home for the owner.

The real estate agent or broker sells the home to the owner and pays the agreed-upon fee to the middleman at closing. As explained hereinabove, the middleman subtracts its commission for handling the entire transaction and pays the remainder to the developer or builder. If possible, during the course of the relationship with the owner prior to entering into a sales agreement, the real estate agent or broker periodically contacts the middleman to keep the middleman apprised of the status of the owner's intentions and affirmatively contacts the middleman when a real estate listing,contract has been established for sale of the home.

The real estate agent or broker is enthusiastic about paying the referral fee when the home is sold because having an inventory of properties to sell is a valuable asset and the ability to easily obtain a legally binding real estate listing is more valuable than merely having a client relationship. At any given time, the prospective client may have relationships with several agents or brokers and there is no telling which of them will be chosen by the owner when the time comes to sell the home. With the inventive agreement in place, there is no guesswork, the owner will choose the real estate agent or broker who has the agreement that binds the owner to do so.

The benefits of the inventive business method for real estate agents and brokers are numerous including the following:

(1) Saves time prospecting for new clients;

(2) Dramatically reduces the expensive proposition of advertising for listings;

(3) More efficient connection to potential home sellers is accomplished;

(4) Begins the relationship between the real estate agent or broker and the owner;

(5) Gives the real estate agent or broker an opportunity to contact a home seller in advance of the listing of the home;

(6) Offers an opportunity to show the home seller the real estate agent's or broker's local knowledge;

(7) Offers the opportunity for a personal visit by the real estate agent or broker to the owner;

(8) Offers a chance to maintain contact through e-mail and newsletter with the owner;

(9) The real estate agent or broker is introduced to family and friends of the prospective purchaser and eventual owner;

(10) Building of new business in a community by having a presence through signage when that home is eventually listed;

(11) By agreeing to be a part of the inventive system, the middleman will assign its rights to the listing to participating real estate agents or brokers. The real estate agent or broker agrees to pay a referral fee and an administrative fee totaling, for example, 20-30%, from their half of the listing commission to the middleman once the property sells;

(12) The real estate agent or broker agrees to monitor the owner to ensure they list their home with the real estate agent or broker when the homeowner decides to sell;

(13) Once the home is listed, the real estate agent or broker must notify the middleman. When the property is sold, the real estate agent or broker is required to wire the referral fee within 48 hours of closing.

As such, an invention has been disclosed in terms of a preferred embodiment thereof with suitable variations which fulfill each and every one of the objects of the invention as set forth hereinabove and provide a new and useful business method for facilitating payment to developer or builder of referral fee for future real estate listing of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. A method of facilitating payment to a developer or builder of a referral fee for a future real estate listing, including the steps of:
a) providing a developer or builder with a first agreement to be executed between said developer or builder and a prospective purchaser of a home owned by said developer or builder, said first agreement providing said prospective purchaser with a reduction of cost of purchasing said home in exchange for said prospective purchaser, should they purchase said home, agreeing that when, sometime in the future, they sell said home, they will list said home in a listing with an agent or broker chosen by said prospective purchaser;
b) providing said developer or builder with a second agreement to be executed between said developer or builder and said agent or broker, said second agreement providing said agent or broker, at a time when said prospective purchaser purchases said home, with said listing, said second agreement obligating said agent or broker to pay said developer or builder a referral fee when said home is sold pursuant to said listing.

2. The method of claim 1, further including the step of paying said referral fee as a percentage of a real estate sale commission.

3. The method of claim 1, further including the step of providing a plurality of second agreements, whereby said prospective purchaser chooses an agent or broker from a list of a plurality of agents and brokers, all of whom have executed a said second agreement with said developer or builder.

4. The method of claim 1, wherein said home was built by said developer or builder.

5. The method of claim 1, wherein said reduction in cost comprises a discount of closing costs.

6. The method of claim 1, wherein said reduction in cost comprises a reduced price for said home.

7. The method of claim 1, further including the step of providing a middleman, said middleman collecting said referral fee from said agent or broker and paying said developer or builder.

8. The method of claim 7, further wherein said middleman subtracts a commission from said referral fee and pays a balance thereof comprising a net referral fee to said developer or builder.

9. The method of claim 8, wherein said net referral fee is paid to said developer or builder via a broker.

10. The method of claim 8, wherein said net referral fee is paid to said developer or builder via a limited liability corporation.

11. The method of claim 7, further including the step of said middleman creating a data base to monitor sales of homes for which a future listing has been committed by an owner thereof.

12. The method of claim 7, further including the step of said middleman soliciting agents and brokers to sign second agreements and maintaining a list of agents and brokers that have signed second agreements.

13. The method of claim 12, further including the step of said middleman providing said developer or builder with said list, said prospective purchaser, upon purchasing said home, choosing an agent or broker from said list.

14. The method of claim 1, wherein said step of providing said developer or builder with said first agreement is carried out by a middleman.

15. The method of claim 7, wherein said step of providing said developer or builder with said first agreement is carried out by said middleman.

16. The method of claim 1, wherein, prior to said developer or builder receiving said referral fee, the further step of said developer or builder obtaining a broker license.

17. A method of facilitating payment to a developer or builder of a referral fee for a future real estate listing, including the steps of:
a) providing a developer or builder who has obtained a broker license or a percentage ownership in a limited liability corporation (LLC) or who has created a legal relationship with a referral fee receiving broker, with a first agreement to be executed between said developer or builder and a prospective purchaser of a home built and owned by said developer or builder, said first agreement providing said prospective purchaser with a reduction of cost of purchasing said home in exchange for said prospective purchaser, should they purchase said home, agreeing that when, sometime in the future, they sell said home, they will list said home in a listing with an agent or broker chosen by said prospective purchaser;
b) providing said developer or builder with a second agreement to be executed between said developer or builder and said agent or broker, said second agreement providing said agent or broker, at a time when said prospective purchaser purchases said home, with said listing, said second agreement obligating said agent or broker to pay said developer or builder a referral fee as a percentage of a real estate commission when said home is sold pursuant to said listing;
c) providing a middleman to collect said referral fee, subtract a middleman commission and pay a remainder to said developer or builder: (1) directly, (2) via said LLC or (3) via said referral fee receiving broker.

18. The method of claim 17, further including the step of providing a plurality of second agreements, whereby said prospective purchaser chooses an agent or broker from a list of a plurality of agents and brokers, all of whom have executed a said second agreement with said middleman.

19. The method of claim 17, wherein said reduction in cost comprises a discount of closing costs.

20. The method of claim 17, further including the step of said middleman creating a data base to monitor sales of homes for which a future listing has been committed by an owner thereof.

21. The method of claim 17, further including the step of said middleman soliciting agents and brokers to sign second agreements and maintaining a list of agents and brokers that have signed second agreements.

22. The method of claim 21, further including the step of said middleman providing said developer or builder with said list, said prospective purchaser, upon purchasing said home, choosing an agent or broker from said list.
